(19) United States
(12) Patent Application Publication
(10) Pub. No.: US 2010/0126051 A1
(43) Pub. Date: May 27, 2010

(54) APPARATUS AND METHOD FOR MOUNTING SIGNS

(76) Inventors: Albert Stephen Kerton, Barrie (CA); Richard William Thomson, Keswick (CA); Peter Geoffrey Cassey, Keswick (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/397,480

(22) Filed: Mar. 4, 2009

(30) Foreign Application Priority Data
Nov. 26, 2008 (CA) 2645224

(51) Int. Cl. G09F 15/00

(52) U.S. Cl. 40/607.13

(57) ABSTRACT

A mounting apparatus can be used to install a sign to a mounting surface. The mounting apparatus permits the sign, in response to an impact, to displace to dissipate or dampen force of the impact and thus prevent or reduce damage to the sign. The mounting apparatus can permit the sign to displace in at least two different directions. The sign can be biased to a neutral position.

This application claims convention priority of Canadian Application No. 2,645,224 filed Nov. 26, 2008.

The section headings used herein are for organizational purposes only and are not to be construed as limiting the described subject matter in any way.

### FIELD

This specification relates to apparatuses and methods for mounting signs. This specification more particularly relates to methods and apparatuses for mounting signs so that when the signs are impacted they displace to reduce damage to the sign.

### INTRODUCTION

Signage can often be damaged by an impact or strain, for example, but not limited to, a vandal hitting or hanging from a sign.

U.S. Pat. No. 3,085,546 (Pelletier) discloses a traffic sign that is provided with means for preventing breakage of same.

U.S. Pat. No. 7,124,993 (Padiak et al.) discloses a system for mounting a sign or graphic display to a structure that allows rotation of the graphic display and provides for automatic return to the initial orientation.

### SUMMARY

In one aspect, a combination includes: a mounting apparatus, the mounting apparatus including a first mounting portion, an intermediate portion coupled to the first mounting portion, and a second mounting portion coupled to the intermediate portion; and a sign, the sign secured to the first mounting portion of the mounting apparatus, the sign movable from a neutral position to (i) swivel relative to the second mounting portion, and (ii) displace away from the second mounting portion.

The intermediate portion can be coupled to the first mounting portion and swivelable about a first axis of rotation, and the sign can be movable in a first direction to swivel about the first axis of rotation relative to the second mounting portion from the neutral position to a first displacement position. The second mounting portion can be coupled to the intermediate portion and swivelable about a second axis of rotation, and the sign can be movable in a second direction to swivel about the second axis of rotation relative to the second mounting portion from the neutral position to a second displacement position. The sign can be movable in a third direction away from the second mounting portion from the neutral position to a third displacement position.

The sign can be biased to the neutral position. The first mounting portion can be coupled to the intermediate portion by a first hinge, and the first hinge can be adapted to bias the intermediate portion against the first mounting portion. The first hinge can comprise a torsion spring for biasing the intermediate portion against the first mounting portion. The second mounting portion can be coupled to the intermediate portion by a second hinge, and the second hinge can be adapted to bias the intermediate portion against the second mounting portion. The second hinge can comprise a torsion spring for biasing the intermediate portion against the second mounting portion.

The first mounting portion, the intermediate portion, and the second mounting portion can be in nested arrangement when the sign is in the neutral position.

The sign can be permitted to swivel about the first axis of rotation up to 90 degrees from the neutral position, and the sign can be permitted to swivel about the second axis of rotation up to 90 degrees from the neutral position.

The sign can also be provided with a protective covering to protect the sign from breaking during an impact.

In another aspect, a method comprises: providing a mounting surface, a sign and a mounting apparatus; installing the sign to the mounting surface by securing the sign to the mounting apparatus, and securing the mounting apparatus to the mounting surface; wherein, once installed onto the mounting surface, the sign is movable from a neutral position to swivel relative to the mounting surface, and the sign is movable from the neutral position to displace away from the mounting surface.

The sign can be movable: in a first direction to swivel about a first axis of rotation relative to the mounting surface from a neutral position to a first displacement position; in a second direction to swivel about a second axis of rotation relative to the mounting surface from the neutral position to a second displacement position; and in a third direction away from the mounting surface from the neutral position to a third displacement position.

The method can further comprise biasing the sign to the neutral position. The mounting apparatus can comprise at least one torsion spring for biasing the sign to the neutral position.

The method can further comprise permitting the sign to swivel about the first axis of rotation up to 90 degrees from the neutral position, and permitting the sign to swivel about the second axis of rotation up to 90 degrees from the neutral position.

In another aspect, a combination of a sign and a vandal-resistant mounting apparatus can be provided, the mounting apparatus including a mounting portion for attachment to a mounting surface, the mounting apparatus adapted to be secured to the sign and to permit the sign to move from a neutral position in at least two different directions relative to the mounting portion to dissipate force of an impact applied to the sign. The mounting apparatus can be adapted to permit the sign to move from the neutral position to swivel relative to the mounting portion and to displace away from the mounting portion. The mounting apparatus can bias the sign to the neutral position.

### DRAWINGS

The skilled person in the art will understand that the drawings, described below, are for illustration purposes only. The drawings are not intended to limit the scope of this specification's teachings in any way.

FIG. 1 shows an exploded partial perspective view of a mounting apparatus disposed between a mounting surface and a sign;

FIGS. 2A, 2B and 2C show side views of a sign mounted to a mounting surface using the mounting apparatus of FIG. 1, the sign shown in respective neutral, first displaced and second displaced positions; and

FIG. 3 shows a side view of a sign mounted to a mounting surface using the mounting apparatus of FIG. 1, the sign shown in a third displaced position.

### DESCRIPTION OF VARIOUS EMBODIMENTS

Various apparatuses or methods will be described below to provide an example of an embodiment of each claimed invention. No embodiment described below limits any claimed invention and any claimed invention may cover apparatuses or methods that are not described below. The claimed inventions are not limited to apparatuses or methods having all of the features of any one apparatus or method described below or to features common to multiple or all of the apparatuses described below. It is possible that an apparatus or method described below is not an embodiment of any claimed invention. The applicant(s), inventor(s) and/or owner(s) reserve all rights in any invention disclosed in an apparatus or method described below that is not claimed in this document and do not abandon, disclaim or dedicate to the public any such invention by its disclosure in this document.

The teachings of this specification relate to apparatuses and methods for mounting a sign to a mounting surface. The mounting surface can be, for example but not limited to, a ceiling surface or a wall surface. A mounting apparatus can be used to mount the sign to the mounting surface, and permit the sign to displace in response to an impact, dampening the force of the impact and thus preventing or reducing damage to the sign. The mounting apparatus can permit the sign to be displaced relative to the mounting surface in at least two directions.

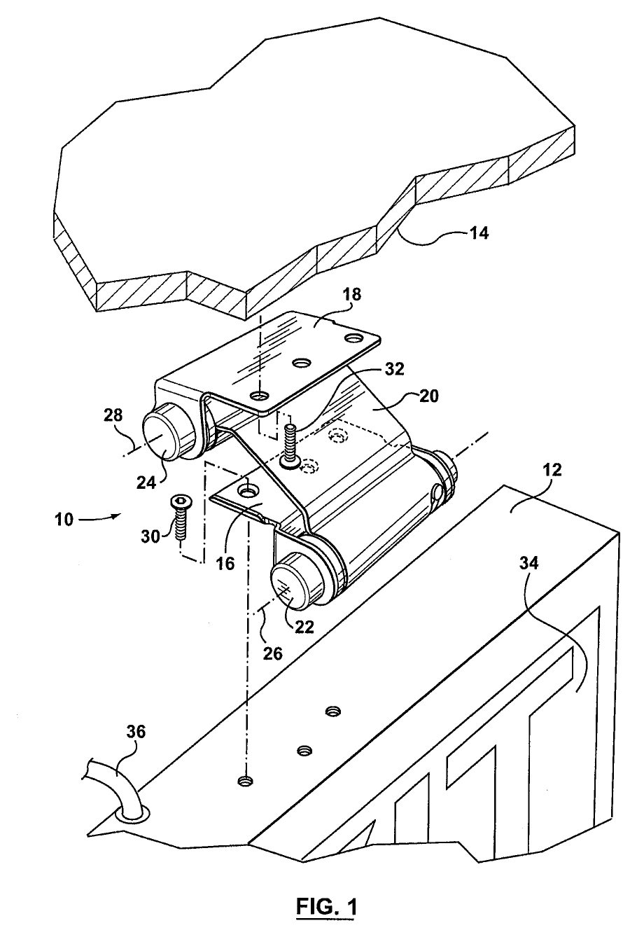

Referring to FIG. 1, an example of a mounting apparatus 10 is shown positioned between a sign 12 and a mounting surface 14. The mounting surface 14 can be, for example but not limited to, a ceiling surface or a wall surface in a building.

The mounting apparatus 10 can include a first mounting portion 16, a second mounting portion 18, and an intermediate portion 20. The first mounting portion 16 can be swivelably coupled to the intermediate portion 20 by a first hinge 22. The second mounting portion 18 can be swivelably coupled to the intermediate portion 20 by a second hinge 24. The first and second hinges 22, 24 define respective first and second axes of rotation 26, 28. In particular, the first mounting portion 16 is adapted to swivel relative to the intermediate portion 20 about the first axis of rotation 26. The second mounting portion 18 is adapted to swivel relative to the intermediate portion 20 about the second axis of rotation 28. The first and second axes of rotation 26, 28 can be substantially parallel.

The first mounting portion 16 of the mounting apparatus 10 can be secured to the sign 12, and the second mounting portion 18 of the mounting apparatus 10 can be secured to the mounting surface 14 (in any order) to install the sign 12 on the mounting surface 14.

The first mounting portion 16 of the mounting apparatus 10 can be secured, directly or indirectly, to the sign 12. For example, as illustrated, at least one fastener 30 can be used to secure the first mounting portion 16 to the sign 12. Although the fastener 30 is illustrated, any suitable means can be employed for securing the first mounting portion 16 to the sign 12, including, for example but not limited to, rivets, screws, bolts, adhesive, etc. The first mounting portion 16 can be secured indirectly to the sign 12 by coupling the first mounting portion 16 to the sign 12 using additional mounting plates or brackets (not shown).

Alternatively, the sign 12 can include a protective cover to protect the sign, for example, but not limited to the sign face, from breaking during an impact. For this variant the first mounting portion 16 of the mounting apparatus 10 can be secured to the protective cover, which contains the sign.

The second mounting portion 18 of the mounting apparatus 10 can be secured, directly or indirectly, to the mounting surface 14. For example, as illustrated, at least one fastener 32 can be used to secure the second mounting portion 18 to the mounting surface 14. Although the fastener 32 is illustrated, any suitable means can be employed for securing the second mounting portion 18 to the mounting surface 14, including, for example but not limited to, rivets, screws, bolts, adhesive, etc. The second mounting portion 18 can be secured indirectly to the mounting surface 14 by coupling the second mounting portion 18 to the mounting surface 14 using additional mounting plates or brackets (not shown).

The sign 12 can include various indicia 34, for example but not limited to, “EXIT”, and a cord 36 can be provided in examples where the sign 12 requires electrical power, for example, for lighting purposes. The mounting surface 14 can be, for example but not limited to, a ceiling surface or a wall surface. The mounting surface 14 need not be horizontal or vertical.

In some examples, the first hinge 22 of the mounting apparatus 10 can be adapted to bias the intermediate portion 20 against the first mounting portion 16. Similarly, in some examples, the second hinge 24 of the mounting apparatus 10 can be adapted to bias the intermediate portion 20 against the second mounting portion 18. In some particular examples, the first and second hinges 22, 24 can each include a torsion spring for biasing the intermediate portion 20 against the first mounting portion 16 and for biasing the intermediate portion 20 against the second mounting portion 18, respectively.

Although hinges 22, 24 are illustrated, other mechanisms could be implemented to couple the portions 16, 18, 20 and allow the portions 16, 18, 20 to pivot or swivel relative to one another, with these mechanisms optionally including a biasing or resistive force.

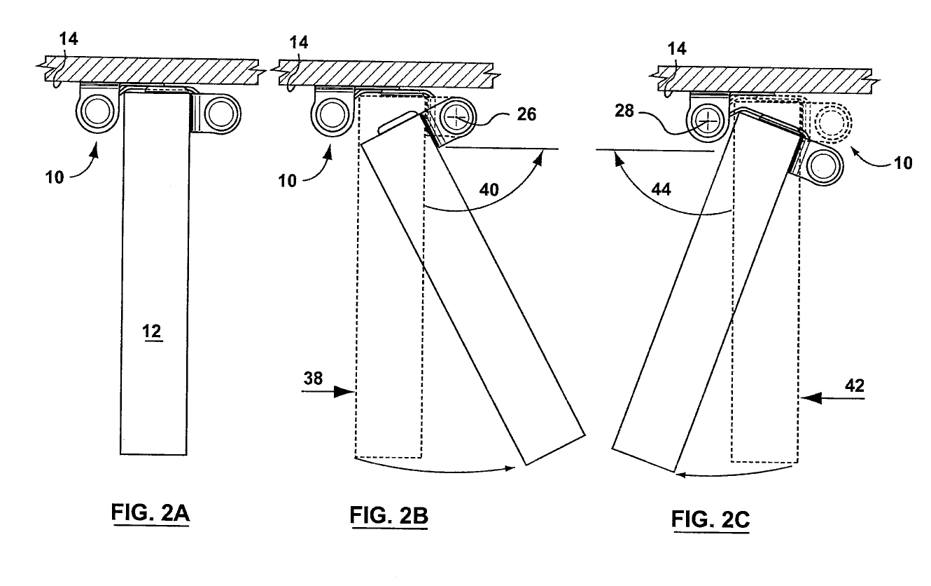

Referring to FIG. 2A (and with continued reference to FIG. 1), the mounting apparatus 10 is shown secured to both the sign 12 and the mounting surface 14, such that the sign 12 is installed on the mounting surface 14. The sign 12 is shown in a neutral position, wherein the first mounting portion 16, the intermediate portion 18 and the second mounting portion 20 of the mounting apparatus 10 are in a nested arrangement (as best seen in FIG. 2A).

Referring to FIG. 2B (and with continued reference to FIG. 1), the sign 12 is movable in a first direction 38 from the neutral position to a first displaced position, wherein the first mounting portion 16 (secured to the sign 12) has swiveled relative to the second mounting portion 18 (secured to the mounting surface 14) about the first axis of rotation 26 of hinge 22. In some examples, the mounting apparatus 10 is adapted to permit the sign 12 to swivel in the first direction 38 at an angle 40 of up to about 60 degrees relative to the neutral position. In some examples, the mounting apparatus 10 is adapted to permit the sign 12 to swivel in the first direction 38 at an angle 40 of up to about 90 degrees relative to the neutral position. In some other examples, the mounting apparatus 10 is adapted to permit the sign 12 to swivel in the first direction 38 at an angle 40 of more than 90 degrees relative to the neutral position (subject to the sign 12 not being obstructed by the mounting surface 14).

Swiveling movement of the sign 12 from the neutral position to the first displaced position can dissipate force of an impact against the sign 12, for example, an impact generally in the direction 38, and thus prevent or reduce damage to the sign 12. In examples where the first hinge 22 is adapted to bias the intermediate portion 20 against the first mounting portion 16, the sign 12 will be biased to return from the first displaced position back to the neutral position, and thus the force of an impact against the sign 12 will be dampened.

Referring to FIG. 2C (and with continued reference to FIG. 1), the sign 12 is movable in a second direction 42 from the neutral position to a second displaced position, wherein the intermediate portion 20 has swiveled relative to the second mounting portion 18 (secured to the mounting surface 14) about the second axis of rotation 28. In some examples, the mounting apparatus 10 is adapted to permit the sign 12 to swivel in the second direction 42 at an angle 44 of up to about 60 degrees relative to the neutral position. In some examples, the mounting apparatus 10 is adapted to permit the sign 12 to swivel in the second direction 42 at an angle 44 up to about 90 degrees relative to the neutral position. In some other examples, the mounting apparatus 10 is adapted to permit the sign 12 to swivel in the second direction 42 at an angle 44 of more than 90 degrees relative to the neutral position.

Swiveling movement of the sign 12 from the neutral position to the second displaced position can dissipate force of an impact against the sign 12, for example, an impact generally in the direction 42, and thus prevent or reduce damage to the sign 12. In examples where the second hinge 24 is adapted to bias the intermediate portion 20 against the second mounting portion 18, the sign 12 will be biased to return from the second displaced position back to the neutral position, and thus the force of an impact against the sign 12 will be dampened.

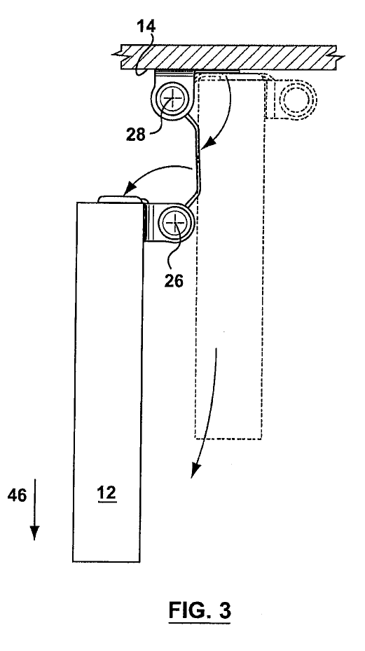

Referring to FIG. 3 (and with continued reference to FIG. 1), the sign 12 is movable in a third direction 46 away from the second mounting portion 18 (secured to the mounting surface 14) from the neutral position to a third displaced position. The first mounting portion 16 (secured to the sign 12) has swiveled relative to the intermediate portion 20 about the first axis of rotation 26 and the intermediate portion 20 has swiveled relative to the second mounting portion 18 (secured to the mounting surface 14) about the second axis of rotation 28, permitting the sign 12 to move away from the mounting surface 14.

Movement of the sign 12 from the neutral position to the third displaced position in the direction 46 away from the mounting surface 14 can dissipate force exerted on the sign 12 generally in the direction 46, for example, a person pulling or hanging onto sign 12, and thus prevent or reduce damage to the sign 12. In examples where the first hinge 22 is adapted to bias the intermediate portion 20 against the first mounting portion 16 and the second hinge 24 is adapted to bias the intermediate portion 20 against the second mounting portion 18, the sign 12 will be biased to return from the third displaced position back to the neutral position, and thus the force of an impact against the sign 12 will be dampened.

The mounting apparatus 10 is relatively simple and can be installed with existing and unmodified signage. The mounting apparatus 10 is also relatively compact, allowing the sign 12 to continue to meet its purpose relatively unhindered. In use, the mounting apparatus 10 can be implemented to provide a vandal-resistant arrangement, wherein the sign is permitted to displace in at least two directions in response to an impact to dissipate or dampen the force of the impact and thus prevent or reduce damage to the sign.

In addition, while the mounting apparatus is illustrated supporting a sign from above, it can be appreciated that the mounting apparatus can be utilized to mount a sign to a wall, in other words the sign is mounted by the apparatus along a side edge of the sign, rather than from above. Similarly, the sign could be mounted from the rear surface of the sign.

While the teachings of this specification are described in conjunction with various embodiments, it is not intended that the teachings herein be limited to such embodiments. The teachings encompass various alternatives, modifications, and equivalents, as will be appreciated by those of skill in the art.

We claim:

1. In combination:
a) a mounting apparatus, the mounting apparatus including a first mounting portion, an intermediate portion coupled to the first mounting portion, and a second mounting portion coupled to the intermediate portion; and
b) a sign, the sign secured to the first mounting portion of the mounting apparatus, the sign movable from a neutral position to (i) swivel relative to the second mounting portion, and (ii) displace away from the second mounting portion.

2. The combination of claim 1, wherein the intermediate portion is coupled to the first mounting portion and swivelable about a first axis of rotation, and wherein the sign is movable in a first direction to swivel about the first axis of rotation relative to the second mounting portion from the neutral position to a first displacement position.

3. The combination of claim 2, wherein the second mounting portion is coupled to the intermediate portion and swivelable about a second axis of rotation, and wherein the sign is movable in a second direction to swivel about the second axis of rotation relative to the second mounting portion from the neutral position to a second displacement position.

4. The combination of claim 3, wherein the sign is movable in a third direction away from the second mounting portion from the neutral position to a third displacement position.

5. The combination of claim 1, wherein the sign is biased to the neutral position.

6. The combination of claim 1, wherein the first mounting portion is coupled to the intermediate portion by a first hinge, and wherein the first hinge is adapted to bias the intermediate portion against the first mounting portion.

7. The combination of claim 6, wherein the first hinge comprises a torsion spring for biasing the intermediate portion against the first mounting portion.

8. The combination of claim 1, wherein the second mounting portion is coupled to the intermediate portion by a second hinge, and wherein the second hinge is adapted to bias the intermediate portion against the second mounting portion.

9. The combination of claim 8, wherein the second hinge comprises a torsion spring for biasing the intermediate portion against the second mounting portion.

10. The combination of claim 1, wherein the first mounting portion, the intermediate portion, and the second mounting portion are in nested arrangement when the sign is in the neutral position.

11. The combination of claim 1, wherein the sign is permitted to swivel about the first axis of rotation up to 90 degrees from the neutral position, and wherein the sign is permitted to swivel about the second axis of rotation up to 90 degrees from the neutral position.

12. The combination of claim 1, wherein the sign is provided with a protective covering.

13. A method comprising:
a) providing a mounting surface, a sign and a mounting apparatus;
b) installing the sign to the mounting surface by securing the sign to the mounting apparatus, and securing the mounting apparatus to the mounting surface;
wherein, once installed onto the mounting surface, the sign is movable from a neutral position to swivel relative to the mounting surface, and the sign is movable from the neutral position to displace away from the mounting surface.

14. The method of claim 12, wherein the sign is movable:
a) in a first direction to swivel about a first axis of rotation relative to the mounting surface from a neutral position to a first displacement position;
b) in a second direction to swivel about a second axis of rotation relative to the mounting surface from the neutral position to a second displacement position; and
c) in a third direction away from the mounting surface from the neutral position to a third displacement position.

15. The method of claim 12, further comprising biasing the sign to the neutral position.

16. The method of claim 14, wherein the mounting apparatus comprises at least one torsion spring for biasing the sign to the neutral position.

17. The method of claim 12, further comprising permitting the sign to swivel about the first axis of rotation up to 90 degrees from the neutral position, and further comprising permitting the sign to swivel about the second axis of rotation up to 90 degrees from the neutral position.

18. A combination of a sign and a vandal-resistant mounting apparatus, the mounting apparatus including a mounting portion for attachment to a mounting surface, the mounting apparatus adapted to be secured to the sign and to permit the sign to move from a neutral position in at least two different directions relative to the mounting portion to dissipate force of an impact applied to the sign.

19. The combination of claim 17, wherein the mounting apparatus is adapted to permit the sign to move from the neutral position to swivel relative to the mounting portion and to displace away from the mounting portion.

20. The combination of claim 17, wherein the mounting apparatus biases the sign to the neutral position.

21. The combination of claim 17, wherein the sign is provided with a protective covering.
